(19) United States
(12) Patent Application Publication
(10) Pub. No.: US 2011/0202574 A1
(43) Pub. Date: Aug. 18, 2011

(54) DOCUMENT MANAGEMENT DEVICE, DOCUMENT MANAGEMENT METHOD AND COMPUTER READABLE MEDIUM

(75) Inventor: Kazuhisa IWASE, Kanagawa (JP)

(73) Assignee: FUJI XEROX CO., LTD., Tokyo (JP)

(21) Appl. No.: 12/857,917

(22) Filed: Aug. 17, 2010

(30) Foreign Application Priority Data
Feb. 16, 2010 (JP) 2010-031616

(51) Int. Cl. G06F 17/30

(52) U.S. Cl. 707/802; 707/E17.005

(57) ABSTRACT

A document management device includes an execution unit, a storage unit, and a recording unit. The execution unit executes a given operation for document information in response to an operation request. The storage unit generates version information based on the given operation when the given operation is executed by the execution unit and stores the document information for which the given operation is executed along with the version information. The recording unit associates the given operation executed by the execution unit and the version information of the document information stored by the storage unit and records the associated given operation and the associated version information as operation history information.

### CROSS-REFERENCE TO RELATED APPLICATIONS

This application is based upon and claims priority under 35 USC 119 from Japanese Patent Application No. 2010-031616, filed Feb. 16, 2010.

### BACKGROUND

### Technical Field

The present invention relates to a document management device, a document management method, and a computer readable medium.

### SUMMARY OF THE INVENTION

According to an aspect of the invention, a document management device includes an execution unit, a storage unit, and a recording unit. The execution unit executes a given operation for document information in response to an operation request. The storage unit generates version information based on the given operation when the given operation is executed by the execution unit and stores the document information for which the given operation is executed along with the version information. The recording unit associates the given operation executed by the execution unit and the version information of the document information stored by the storage unit and records the associated given operation and the associated version information as operation history information.

### BRIEF DESCRIPTION OF THE DRAWINGS

Exemplary embodiments of the invention will be described in detail based on the following figures, wherein:

FIG. 1 is a diagram showing an example of the configuration of a document management system according to an exemplary embodiment of the present invention;

FIG. 2 is a block diagram showing an example of the configuration of a document management server;

FIG. 3 is a diagram showing an example of operation history information recorded by an operation history recording unit;

FIG. 4 is a diagram showing an example of a document list display image generated by a UI generation unit;

FIG. 5 is a flowchart showing an operation related to a given operation of the document management server;

FIGS. 6A and 6B are diagrams showing another example of a document list display image generated by the UI generation unit and an operation history display image displayed by an operation history display unit;

FIG. 7 is a flowchart showing an operation related to operation history display of the document management server;

FIG. 8 is diagram showing another example of a document list display image generated by the UI generation unit and a check display image displayed by an operation history checking unit; and

FIG. 9 is a flowchart showing an operation related to checking of an operation history of the document management server.

### DETAILED DESCRIPTION

(Configuration of Document Management System)

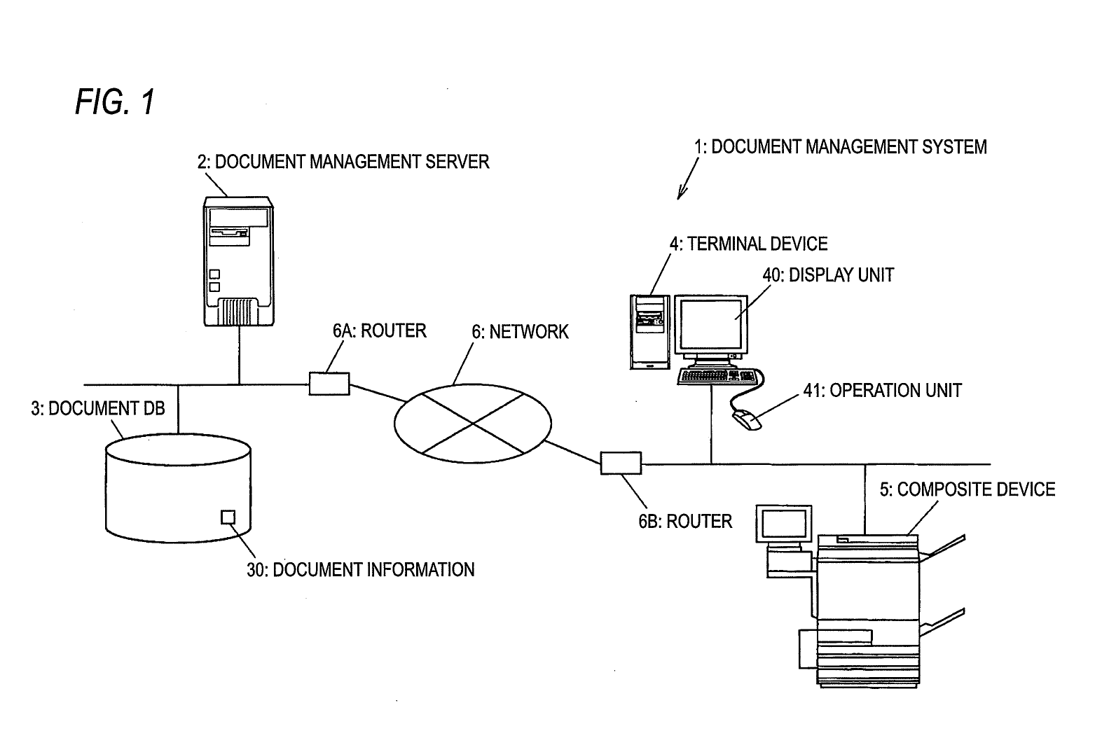

FIG. 1 is a diagram showing an example of the configuration of a document management system according to an exemplary embodiment of the present invention.

The document management system 1 is constituted by respectively connecting a document management server 2 and a document database (hereinafter, referred to as “DB”) 3 connected to a router 6A, and a terminal device 4 and a |multi-function |device 5 connected to a router 6B by a network 6.

The document management server 2 browses and edits document information 30 stored in the document DB 3 in response to a request of the terminal device 4, and also manages version information of the document information 30 and an operation instruction made for the document information 30 from the terminal device 4.

Here, “version information” indicates that a revision process or a given operation for the document information 30 stored in the document DB 3 is executed, and is updated every time the revision process or the given operation is executed. When the revision process such as an edit process or a storage process is executed, a version number to be managed in the document management server 2 or the document DB 3 is changed. When the given operation is executed, an extension is added to the version number in response to operation content of the given operation without performing the above-described revision process, that is, without changing the version number. The method of updating the version information is not limited thereto.

The document DB 3 stores the document information 30 created by application software such as word processing software, image drawing software, or spreadsheet software.

The terminal device 4 has a display unit 40 such as an LCD (Liquid Crystal Display) and an operation unit 41 such as a keyboard or a mouse, transmits an operation request for the document information 30 to the document management server 2 in response to content input to the operation unit 41, and displays a user interface (hereinafter, referred to as “UI”) to the display unit 40 by receiving display information from the document management server 2.

The multi-function device 5 has a printing function, a facsimile function, a scanner function, and the like, and may be controlled from the terminal device 4. Also, the multi-function device 5 includes a plurality of units corresponding to respective functions as well as a single unit.

The network 6 is a public line, the Internet, or the like, and is connected to be communicable between the routers 6A and 6B.

A communication network constituted by the routers 6A and 6B is an LAN (Local Area Network) or the like. Wired communication and wireless communication may be used in the LAN.

The multi-function device 5 and the terminal device 4 show single bodies in the same figure, but may respectively have a plurality of devices.

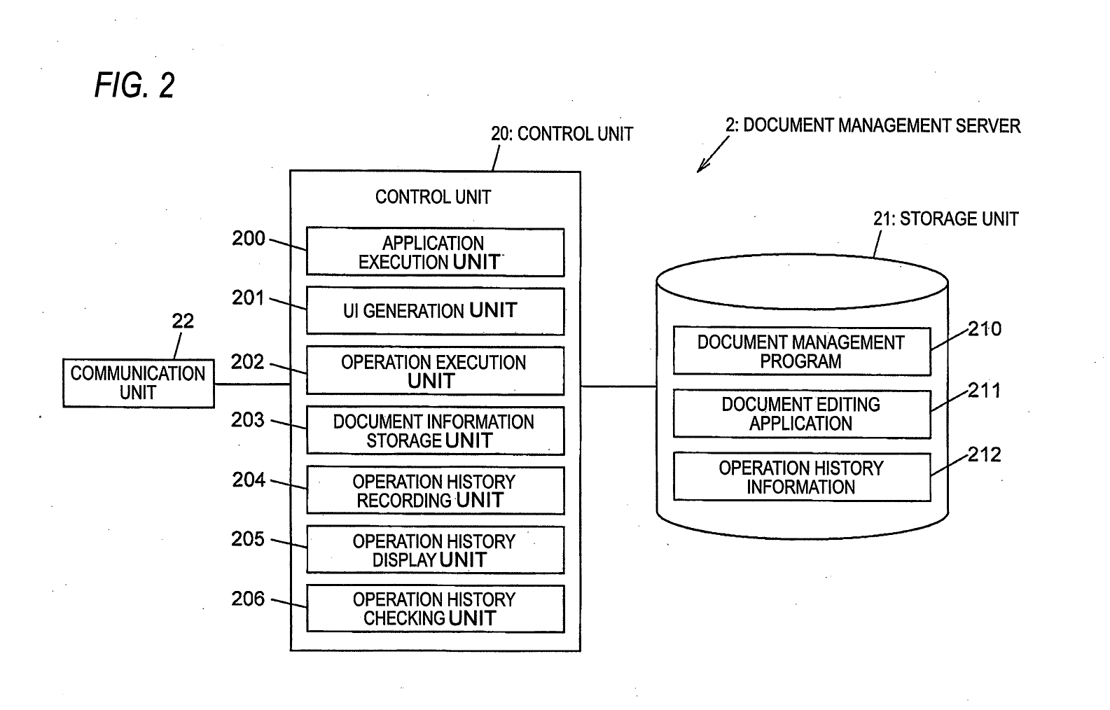

FIG. 2 is a block diagram showing an example of the configuration of the document management server 2.

The document management server 2 has a control unit 20 which includes a CPU (Central Processing Unit), a memory, and the like, controls each part, and also executes various programs, a storage unit 21 which includes a storage device such as an HDD (Hard Disk Drive) or a flash memory and stores information, and a communication unit 22 which communicates with the document DB 3, the terminal device 4, and the multi-function device 5 via the router 6A and the network 6.

By executing a document management program 210 to be described later, the control unit 20 functions as an application execution unit 200, an UI generation unit 201, an operation execution unit 202, a document information storage unit 203, an operation history recording unit 204, an operation history display unit 205, an operation history checking unit 206, and the like.

By executing a document editing application 211, the application execution unit 200 executes the browsing and editing of the document information 30 stored in the document DB 3, the creation of new document information to be stored in the document DB 3, or the like in response to a request of the terminal device 4.

The UI generation unit 201 generates information capable of being displayed as a UI on the display unit 40 of the terminal device 4 on the basis of the unit 200 to 206 of the control unit 20.

In response to a request of the terminal device 4, the operation execution unit 202 executes a given operation for the document information 30, for example, printing, mail transmission, FAX transmission, download directed to the terminal device 4, or the like.

The document information storage unit 203 stores the document information 30, having version information of a point in time when the operation execution unit 202 has executed a given operation, in the document DB 3.

The operation history recording unit 204 records a history of the given operation executed by the operation execution unit 202 as operation history information 212 in the storage unit 21. The operation history information 212 has a type of given operation, document information of an operation target, version information of the document information, an operator, an operation time, and the like.

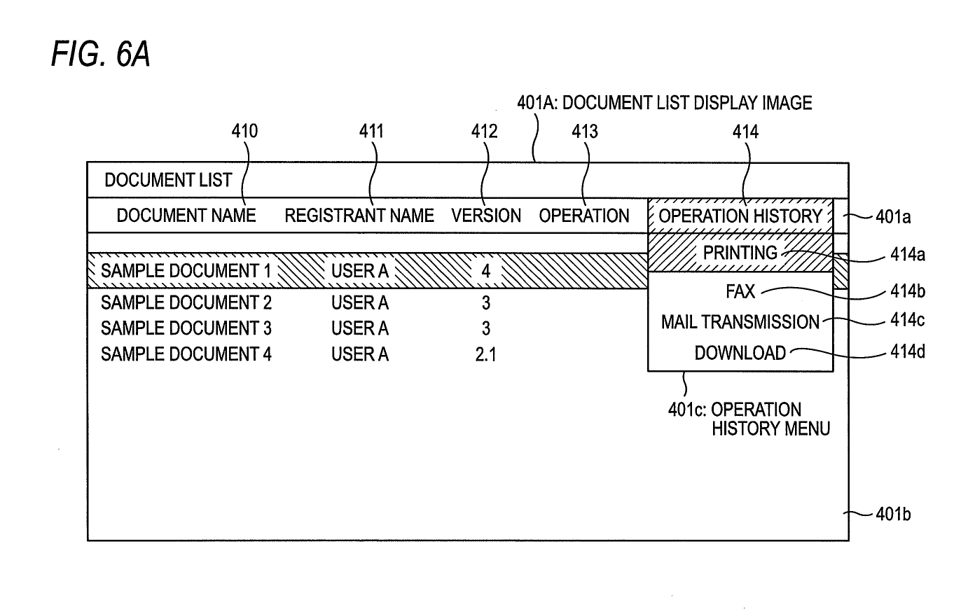

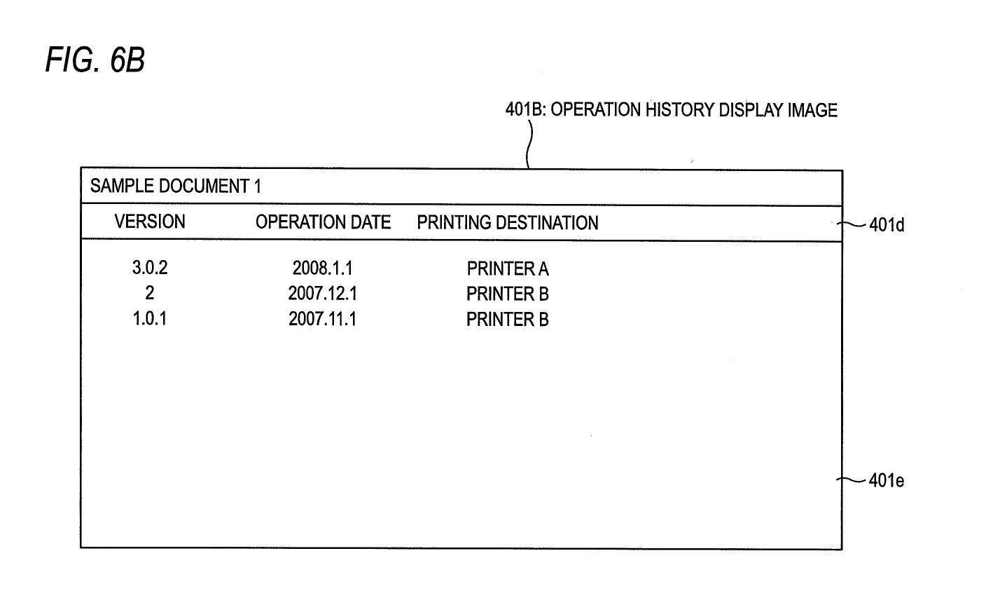

The operation history display unit 205 transmits an operation history display image (see FIG. 6B) 401B created on the basis of the operation history information 212 of the document information selected by the request of the terminal device 4 to the terminal device 4, and causes the display unit 40 of the terminal device 4 to display the operation history display image 401B.

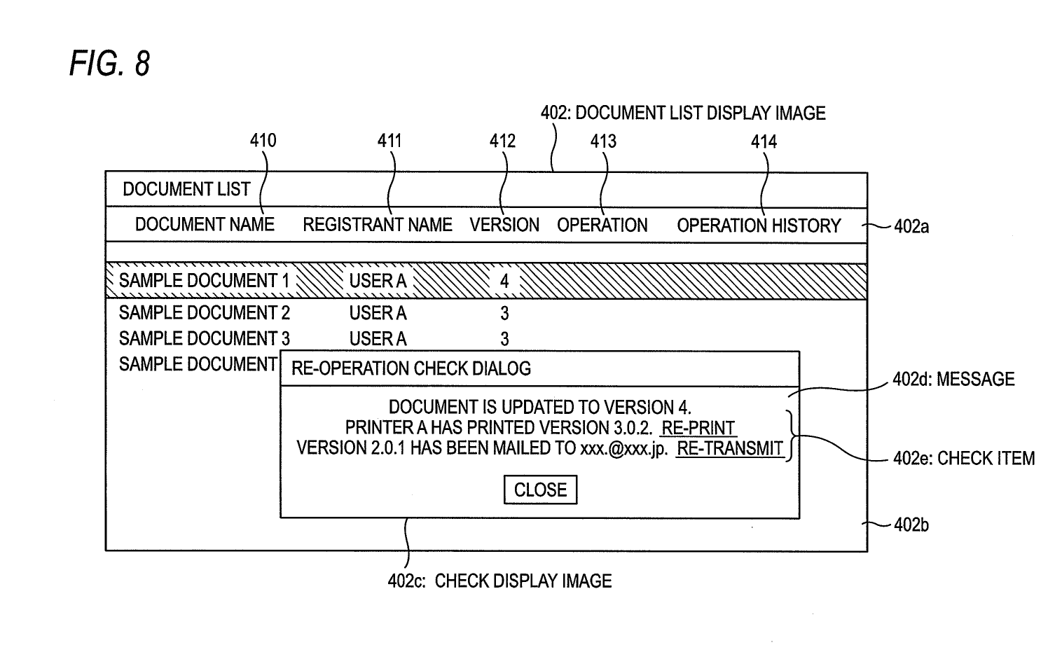

When the document information selected by a request of the terminal device 4 is updated and the version information is new, the operation history checking unit 206 transmits a check display image (see FIG. 8) 402c indicating a notification thereof to the terminal device 4 and causes the display unit 40 of the terminal device 4 to display the check display image 402c.

The storage unit 21 stores the document management program 210 which causes the control unit 20 to be operated as the above-described unit 200 to 206, the document editing application 211 to be executed by the application execution unit 200, and the operation history information 212 to be recorded by the operation history recording unit 204.

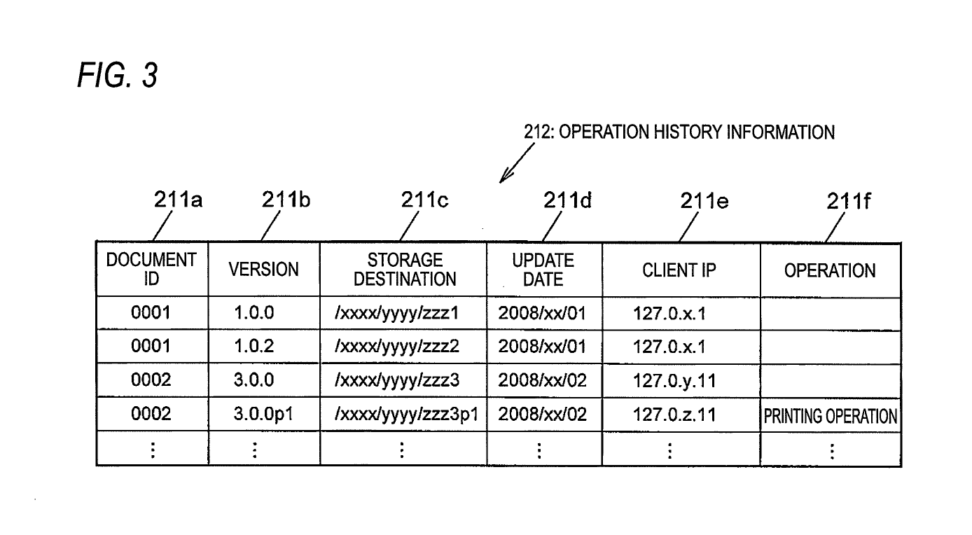

FIG. 3 is a diagram showing an example of the operation history information 212 recorded by the operation history recording unit 204.

The operation history information 212 has a document ID field 211a indicating identification information of the document information 30, a version field 211b indicating a version number as the version information of the document information 30, a storage destination field 211c indicating a storage destination of the document information 30, an update date field 211d indicating a date on which the version number written to the version field 211b is updated, a client IP address field 211e indicating identification information of a user storing the document information 30, and an operation field 211f to which given operation content is written when a preset given operation is executed.

(Operation of Document Management System)

Hereinafter, the operation of the document management system 1 according to an exemplary embodiment of the present invention will be described with reference to the drawings.

(1) Basic Operation of Document Management System

First, the user operates the operation unit 41 of the terminal device 4 for accessing the document management server 2. The terminal device 4 performs various operations in response to input operation content and transmits a request to an external device, but an example in which the terminal device 4 executes an application or the like to be operated on the document management server 2 by accessing the document management server 2 will be described.

The terminal device 4 transmits a request for activating an application via the router 6B, the network 6, and the router 6A to the document management server 2. The application execution unit 200 of the document management server 2 receives the request from the terminal device 4, executes the document editing application 211, and outputs the execution result. The UI generation unit 201 generates a format of information (hereinafter, referred to as “UI information”) capable of being displayed as a UI on the display unit 40 of the terminal device 4 on the basis of the execution result output by the application execution unit 200, and transmits the UI information to the terminal device 4.

The terminal device 4 receives the UI information from the document management server 2 and displays the received UI information on the display unit 40. In response to UI content displayed on the display unit 40 of the terminal device 4, the user operates the operation unit 41 to edit the document information or the like. When a storing request is made by the user after the document information is edited by the application execution unit 200, the document information storage unit 203 executes a revision process by updating the version information of the document information to a new version and storing the updated version information so that the version number of the version field 211b in which the document ID of the document ID field 211a is “0001” is updated from “1.0.0” to “1.0.2” in the operation history information 212 shown in FIG. 3.

In response to a request of the terminal device 4, the UI generation unit 201 generates information for browsing the document information 30 stored in the document DB 3, and transmits the information to the terminal device 4. The terminal device 4 receives the information from the UI generation unit 201, and displays a document list display image 400 on the display unit 40.

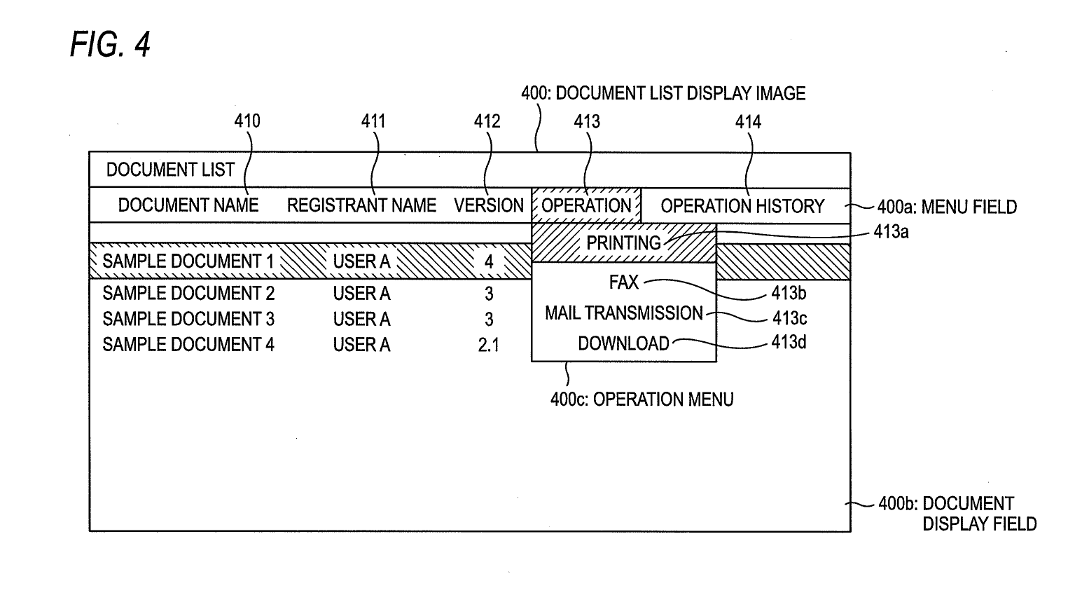

FIG. 4 is a diagram showing an example of a document list display image generated by the UI generation unit 201.

The document list display image 400 has a menu field 400a in which items 410 to 414 of a document name, a registrant name, a version, an operation, an operation history, and the like are displayed, a document display field 400b in which a list of document information 30 stored in the document DB 3 is displayed, and an operation menu 400c to be displayed at the time of selecting document information in the document display field 400b and selecting the “operation” item 413 in the menu field 400a. The operation menu 400c has items 413a to 413d (operation contents) belonging to given operations of printing, FAX, mail transmission, download, and the like which are not associated with the revision process in the document management server 2.

(2) Execution of Operation for Document Information

In the document list display image 400 displayed on the display unit 40 of the terminal device 4, the user selects the document information 30 of the document display field 400b and an item belonging to a given operation, for example, the “printing” item 413a, from the operation menu 400c, by using the operation unit 41. The terminal device 4 transmits a request for executing printing as the operation content of the selected “printing” item 413a for the document information selected in the document display field 400b to the document management server 2.

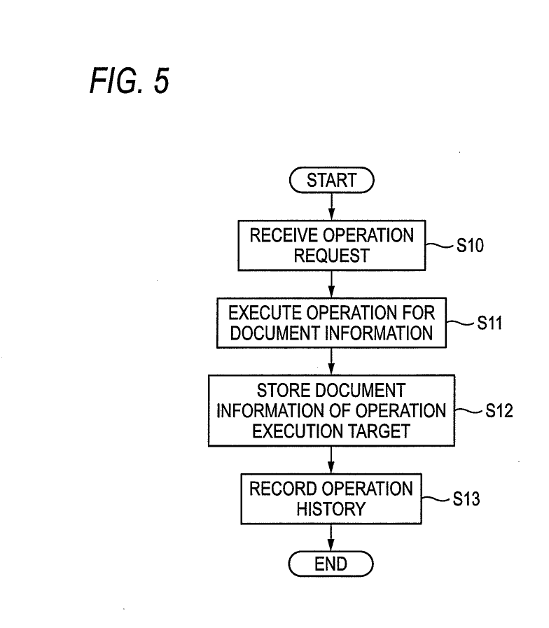

FIG. 5 is a flowchart showing an operation related to a given operation of the document management server 2.

When a request, for example a request for printing the document information 30, is received from the terminal device 4 (S10), the operation execution unit 202 of the document management server 2 executes the given operation selected for the document information 30 of the document DB 3 (S11). For example, “printing” is executed.

Next, when the operation execution unit 202 executes the given operation, the document information storage unit 203 stores document information 30 as a document, having given version information at a point in time when the given operation is executed, in the document DB 3 (S12). For example, the given version information in the case where the given operation is executed is set as version information to which an extension of “p1” or the like corresponding to the content of the given operation is added without changing the version number based on the revision process of the document management server 2 like “3.0.0p1” shown in the version field 211b of the operation history information 212 of FIG. 3. As the extension, “m1” is added in the case where the given operation is first time mail transmission, and |“f2” is added in the case of second time |FAX transmission. In the case where the given operation is executed, a new version number may be set instead of adding given version information.

Next, the operation history recording unit 204 records the given operation executed by the operation execution unit 202 and the content of document information stored by the document information storage unit 203 to the operation history information 212 (S13). For example, as shown in the lowest portion of the operation history information 212 of FIG. 3, a document information ID “002” is recorded to the document ID field 211a, given version information “3.0.0p1” is recorded to the version field 211b, a storage destination “/xxxx/yyyy/zzz3p1” is recorded to the storage destination field 211c, an IP address “127.0.z.11” of the terminal device 4 is recorded to the client IP field 211e, and “printing operation” is recorded to the operation field 211f.

(3) Operation History Display Operation for Document Information

In response to a request of the terminal device 4, the operation history display unit 205 generates information for browsing the operation history information 212 stored in the storage unit 21. On the basis of the information, the UI generation unit 201 generates UI information and transmits the generated UI information to the terminal device 4. The terminal device 4 receives the information from the UI generation unit 201 and displays an operation history display image 401B shown in FIG. 6 on the display unit 40.

FIGS. 6A and 6B are diagrams showing another example of a document list display image generated by the UI generation unit 201 and an operation history display image displayed by the operation history display unit 205.

A document list display image 401A has a menu field 401a in which items of a document name, a registrant name, a version, an operation, an operation history, and the like are displayed, a document display field 401b in which a list of document information 30 stored in the document DB 3 is displayed, and an operation history menu 401c to be displayed at the time of selecting document information in the document display field 401b and selecting the “operation history” item 414 in the menu field 401a. The operation history menu 401c has items 414a to 414d belonging to given operations of printing, FAX, mail transmission, download, and the like.

An operation history display image 401B has a menu field 401d in which items of a version, an operation date, a printing destination, and the like are displayed and an operation history display field 401e in which content of the operation history information 212 corresponding to an item selected in the document list display image 401A is displayed.

In the document list display image 401A displayed on the display unit 40 of the display device 4, the user selects document information of the document display field 401b and an item of the operation history menu 401c, for example, the “printing” item 414a using the operation unit 41. The terminal device 4 transmits a request for acquiring an operation history corresponding to the selected “operation history” item 414 among operation histories previously executed for the selected document information in the document display field 401b to the document management server 2.

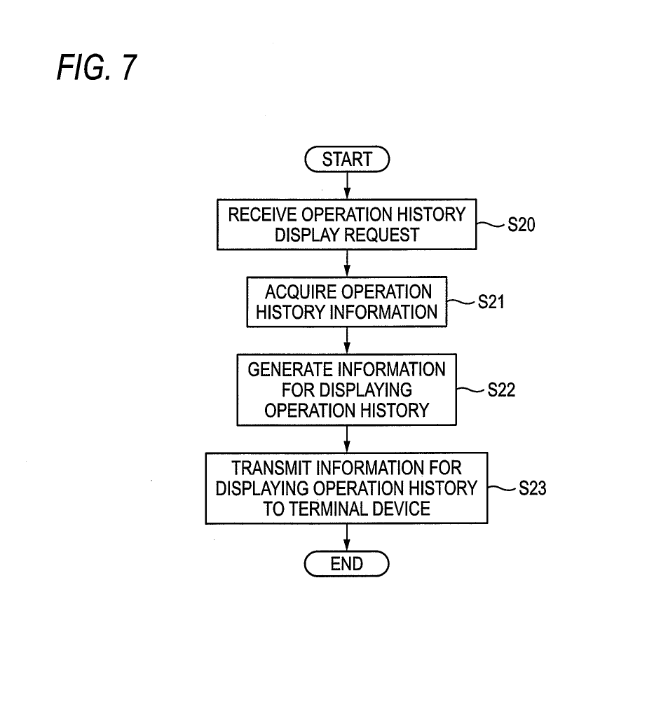

FIG. 7 is a flowchart showing an operation related to operation history display of the document management server 2.

When a request is received from the terminal device 4 (S20), the operation history display unit 205 of the document management server 2 acquires a corresponding operation history from the operation history information 212 of the storage unit 21 (S21). Next, the UI generation unit 201 generates information for displaying the operation history display image 401B as a UI on the display unit 40 of the terminal device 4 on the basis of the operation history acquired by the operation history display unit 205 (S22), and transmits the generated information to the terminal device 4 (S23).

The terminal device 4 receives the information for displaying the UI from the document management server 2, and displays the operation history display image 401B on the display unit 40.

(4) Check Display Operation for Operation History

When the document information 30 is updated and the version information is changed, the operation history checking unit 206 generates information for displaying a notification thereof to the user who is browsing the document information 30 stored in the document DB 3 in response to a request of the terminal device 4. On the basis of the information, the UI generation unit 201 generates UI information and transmits the generated UI information to the terminal device 4. The terminal device 4 receives the information from the UI generation unit 201, and displays a check display image 402c on the display unit 40.

FIG. 8 is diagram showing another example of a document list display image generated by the UI generation unit 201 and a check display image displayed by the operation history checking unit 206.

A document list display image 402 has a menu field 402a in which items 410 to 414 of a document name, a registrant name, a version, an operation, an operation history, and the like are displayed and a document display field 402b in which a list of document information 30 stored in the document DB 3 is displayed.

A check display image 402c is an image to be displayed in the case where version information for the document information 30 selected in the document display field 402b is updated, and has a message 402d of content, for example, indicating “Document is updated to version 4”, so as to report the update, and a check item 402e for checking whether or not an operation history is re-executed in the current document information 30.

In the document list display image 402 displayed on the display unit 40 of the terminal device 4, the user selects the document information of the document display field 402b by using the operation unit 41. The terminal device 4 transmits a notification indicating that the document information is selected in the document display field 402b to the document management server 2.

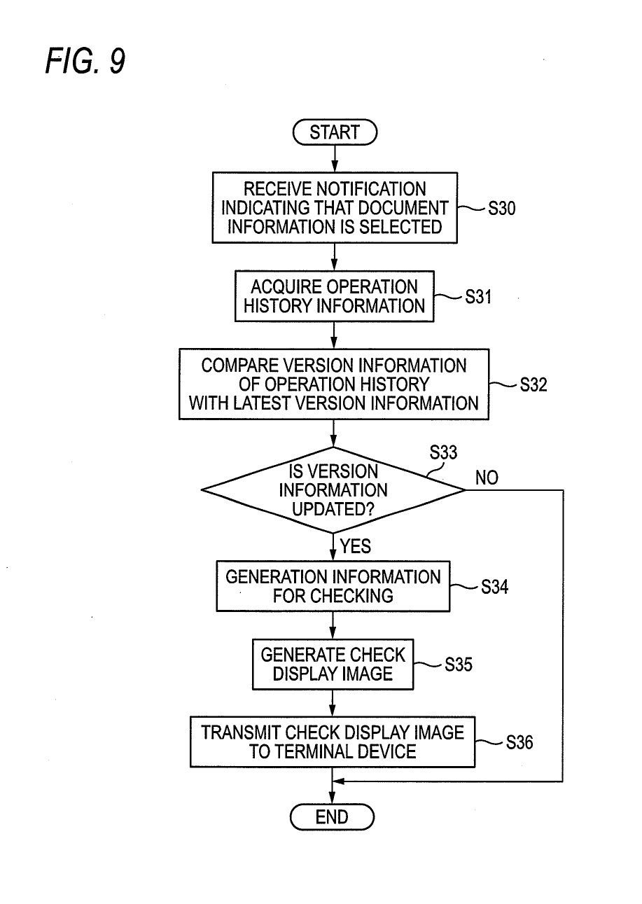

FIG. 9 is a flowchart showing an operation related to checking of an operation history of the document management server 2.

When a notification indicating that the document information 30 is selected is received from the terminal device 4 (S30), the operation history checking unit 206 of the document management server 2 acquires an operation history corresponding to the document information 30 selected from the operation history information 212 of the storage unit 21 (S31). Next, the operation history checking unit 206 compares the version information of the document information 30 in the operation history of the user selecting the document information with the version information of the current document information 30 (S32). When the version information of the document information is updated (S33: Yes), information for checking a notification thereof is generated (S34). Next, the UI generation unit 201 generates UI information for displaying the check display image 402c as a UI on the display unit 40 of the terminal device 4 on the basis of the information generated by the operation history checking unit 206 (S35), and transmits the generated UI information to the terminal device 4 (S36).

The terminal device 4 receives the UI information from the document management server 2, and displays the check display image 402c on the display unit 40.

Next, the user selects the check item 402e by using the operation unit 41 in the check display image 402c displayed on the display unit 40 of the terminal device 4, if necessary. The terminal device 4 transmits a request of an operation corresponding to content selected in the check item 402e to the document management server 2.

When the operation execution unit 202 of the document management server 2 receives the request from the terminal device 4, the operation execution unit 202 executes an operation selected for the document information 30 having latest version information of the document DB 3.

### Other Exemplary Embodiments

The present invention is not limited to the above-described exemplary embodiments, and various modifications are possible in the scope without departing from the subject matter of the present invention. For example, the operation history display image 401B described in “(3) Operation History Display Operation for Document Information” displays an operation history of the user who performs the operation, but may display operation histories of other low-level users to a user responsible for management by pre-setting or may display operation histories of all users to a manager of the document DB 3.

When the document information is updated, the check display image 402c described in “(4) Check Display Operation for Operation History” displays a notification thereof, but may be displayed in the case where the update is made for each type of given operation. It may be displayed in the case where the number of updates is greater than a preset threshold value.

The application execution unit 200, the UI generation unit 201, the operation execution unit 202, the document information storage unit 203, the operation history recording unit 204, the operation history display unit 205, and the operation history checking unit 206 used in this exemplary embodiment of the present invention may be read in from a storage medium of a CD-ROM or the like to the storage unit within the device, and may be downloaded from a server device or the like connected to a network such as the Internet to the storage unit within the device. Some or all of the units used in the above-described exemplary embodiment may be implemented by hardware such as an ASIC.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. A document management device comprising:
an execution unit that executes a given operation for document information in response to an operation request;
a storage unit that generates version information based on the given operation when the given operation is executed by the execution unit and that stores the document information for which the given operation is executed along with the version information; and
a recording unit that associates the given operation executed by the execution unit and the version information of the document information stored by the storage unit and that records the associated given operation and the associated version information as operation history information.

2. The document management device according to claim 1 further comprising:
a display unit that displays the version information associated with the given operation designated by the operation history information.

3. The document management device according to claim 1 further comprising:
a checking unit that causes a version information update to be displayed when current version information of the document information is newer than version information recorded to the operation history information.

4. The document management device according to claim 3,
wherein the checking unit causes whether or not a given operation for the operation history information is executed for the document information corresponding to the current version information to be checked.

5. A document management method comprising:
executing a given operation for document information in response to an operation request;
generating version information based on the given operation when the given operation is executed by the execution unit;
storing the document information for which the given operation is executed along with the version information;
associates the given operation executed by the execution unit and the version information of the document information stored by the storage unit; and
recording the associated given operation and the associated version information as operation history information.

6. A computer readable medium storing a program causing a computer to execute a process for managing document, the process comprising:
executing a given operation for document information in response to an operation request;
generating version information based on the given operation when the given operation is executed by the execution unit;
storing the document information for which the given operation is executed along with the version information;
associates the given operation executed by the execution unit and the version information of the document information stored by the storage unit; and
recording the associated given operation and the associated version information as operation history information.
